(19) United States
(12) Patent Application Publication
(10) Pub. No.: US 2007/0072038 A1
(43) Pub. Date: Mar. 29, 2007

(54) Fuel cartridge

(76) Inventors: Tomoichi Kamo, Naka (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/359,372

(22) Filed: Feb. 23, 2006

(30) Foreign Application Priority Data
Sep. 28, 2005 (JP) 2005-281065

(51) Int. Cl. H01M 8/04; B67D 3/00

(52) U.S. Cl. 429/34; 222/187

(57) ABSTRACT

A fuel cartridge is applicable to the fuel cell comprising an anode, a cathode, a polymer electrolyte membrane and a fuel wicking structure for feeding liquid fuel to the anode. The fuel cartridge comprises a fuel container and a porous fuel transport wick. The porous fuel transport for transporting the liquid fuel to the fuel cell, is incorporated in the fuel container. The fuel cartridge is configured to feed the liquid fuel stored in the cartridge to the fuel cell through the porous fuel transport wick, with assist of the negative capillary attraction which occurs in the fuel wicking structure depending on fuel consumption at the anode.

### CLAIM OF PRIORITY

The present application claims priority from Japanese application serial no. 2005-281065, filed on Sep. 28, 2005, the content of which is hereby incorporated by reference into this application.

### BACKGROUND OF THE INVENTION

The present invention relates to a fuel cartridge for supplying a fuel to a fuel cell using liquid.

The fuel cell using liquid fuel has higher energy density and easy handling as compared with a fuel cell using gas fuel. Because of these characteristics, development efforts have been made to produce a portable fuel cell.

A secondary battery represented by a lithium secondary battery constitutes the main steam of a portable power supply. As compared with the secondary battery, the fuel cell does not require charging time. In principle, the fuel cell generates power almost permanently merely by supplying the fuel cell with fuel. Two methods have been proposed to supply the fuel; a method of injecting the fuel into the satellite fuel tank of the fuel cell and a method of using a fuel cartridge. The fuel cartridge is a container with a fuel stored therein. It is intended to replenish the fuel if there is a shortage of fuel as a result of power generation in the fuel cell. In the fuel cell, there are advantages of being able to carry the fuel cell during the travel, and driving the fuel cell to get power at any desired time and place.

In one of the fuel cartridges having been proposed so far, the fuel cell is supplied with liquid fuel utilizing the capillary action of the wicking structure as shown in Patent Document 1 (Official Gazette of Japanese Patent publication No. 2003-109633).

In the liquid fuel cell, since the liquid transport is carried out using the capillary action on the order of several Pa, the liquid wicking speed and the speed of liquid reaching to one end from the other end of the capillary tube are too low. Consequently, when a current greater than a certain level is to be extracted from the fuel cell, the fuel cell cannot be supplied with a sufficient amount of the fuel required power generation of the fuel cell, in some cases.

### SUMMARY OF THE INVENTION

A fuel cartridge for use in a fuel cell of the present invention has the following arrangement basically. It is comprised of: a fuel container for storing the liquid fuel; and a porous fuel transport wick for transporting the liquid fuel to the fuel cell, and which is incorporated in the fuel container.

The fuel stored in the fuel container can be supplied (replenished) to the fuel cell through the porous fuel transport wick and negative capillary attraction by the consumption of the liquid fuel by the anode of the fuel cell. Incidentally, the negative capillary attraction is produced at a fuel wicking structure in the fuel cell when the fuel wicking structure supplies the fuel to the anode of the fuel cell and the fuel is consumed with the anode.

In a liquid fuel direct type fuel cell, a continuous transport path is formed by using a porous material in combination. The fuel is fed by assist of the negative capillary attraction produced in the anode. This arrangement provides a highly efficient power supply without requiring the driving force by an auxiliary device.

### BRIEF DESCRIPTION OF THE DRAWINGS

FIG. 1 is a cross sectional view representing the outline of a fuel cell loaded with a fuel cartridge in the present invention;

FIG. 2 is a schematic view representing the lamination structure of the fuel cell in the present embodiment;

FIG. 3 (A) is a cross sectional view of a connector of the present invention, and FIG. 3 (B) is a schematic view when loaded;

FIG. 4 (A) is a cross sectional view of a connector of the present invention, and FIG. 4 (B) is a schematic view when loaded;

FIG. 5 is a cross sectional view representing the outline of a fuel cell loaded with a fuel cartridge of the present invention;

FIG. 6 is a cross sectional view representing the outline of a fuel cartridge of the present invention;

FIG. 7 (A) is a cross sectional view of a connector of the present invention, and FIG. 7 (B) is a schematic view when loaded;

FIG. 8 is a cross sectional view representing the outline of a fuel cartridge of the present invention; and

FIG. 9 (A) is a cross sectional view of a connector of the present invention, and FIG. 9 (B) is a schematic view when loaded.

### DETAILED DESCRIPTION OF THE INVENTION

The following describes the embodiments of the present invention, without the present invention being restricted thereto.

In the fuel cell wherein the methanol of the present embodiment is employed as a fuel, the chemical energy of methanol is converted directly into the electric energy in the following electrochemical reaction. On the anode side, the aqueous solution of methanol having been supplied is subjected to reaction according to the equation (1), and is dissociated into carbon dioxide gas, hydrogen ion and electron.
CH₃OH+H₂O→CO₂+6H⁺+6e⁻ (1)

The hydrogen ion having been produced moves from the anode to the cathode in the polymer electrolyte membrane, and reacts with the oxygen gas having been diffused from air on the cathode electron, and the electron on the electrode according equation (2), whereby water is produced.
6H⁺+3/2O₂+6e⁻3H₂O (2)

In all chemical reactions resulting from power generation, methanol is oxidized by oxygen gas to generate carbon dioxide gas and water, as described in the equation (3). The chemical reaction equation is the same as that in methanol flame combustion.
CH₃OH+3/2O₂→CO₂+3H₂O (3)

The open circuit voltage of the unit cell is approximately 1.2 volts and is 0.85 through 1.0 volts in real terms under the influence of the fuel permeating the polymer electrolyte membrane although there is no particular restriction. The voltage of 0.2 through 0.6 volts is selected under the practical operating conditions. Thus, when actually used as a power source, unit cells are connected in series to ensure that a predetermined voltage will be obtained according to the requirements of a loaded device. The output current density of the unit cell varies according to the electrode catalyst, electrode structure and other factors. The area for power generation section of the cell is selected effectively to ensure that a predetermined current will be obtained. Further, the fuel cell capacity can be adjusted by arranging a parallel connection as appropriate.

The following describes the fuel cell of the present embodiment.

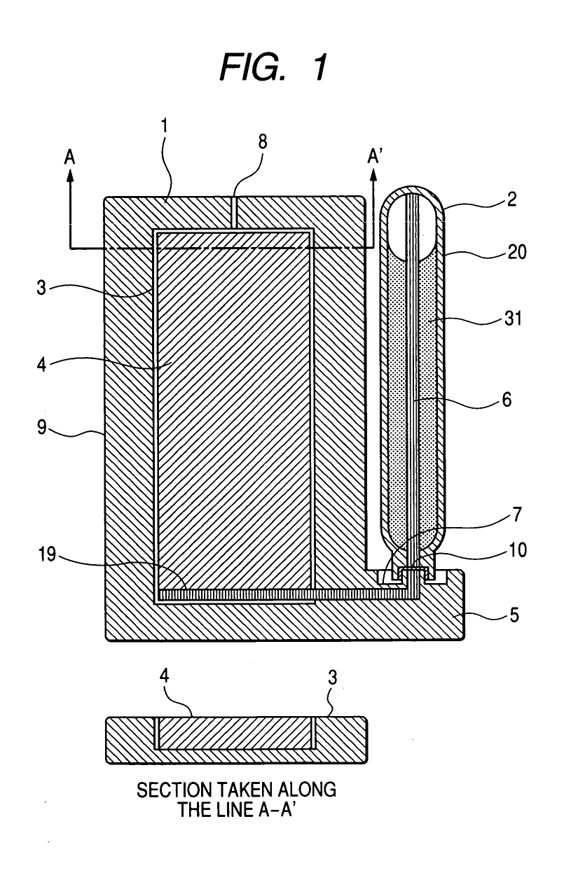

FIG. 1 is a schematic diagram representing the connection between a fuel cell 1 and a fuel cartridge 2 in the embodiment of the present invention.

In fuel cell 1, a fuel wicking structure 4 for wicking liquid fuel is incorporated in a fuel chamber 3. A fuel chamber frame 9 of the fuel cell 1 is provided with a fuel cartridge connector 5. A transport wick 19 is located at a center of the connector 5, and is connected with the fuel wicking structure member 4. A fuel cartridge 2 is loaded to the fuel cell 1 and connected to the connector 5. The fuel cartridge 2 is composed of a fuel container 2, a fuel transport wick 6. The fuel container 2 is filled with liquid fuel 31 and houses the fuel transport wick 6.

As shown in FIGS. 3(A) and (B), In the fuel cell 1, a connector side-part of the fuel transport wick 19 has the form of a male connector portion so as to be capable of connecting with the fuel transport wick 6 of the fuel cartridge 2 through a passage hole (which is formed an outlet side of the fuel cartridge 2). The male connector of fuel transport wick 19 serves as an element of the connector 5 of the fuel cell 1. The fuel cartridge connector 5 has a recess 5A for receiving a part of the fuel cartridge 2. The male connector portion of the fuel transport wick 19 protrudes at the center of the recess 5A, and one or more air vents 7a are provided at the bottom of the recess 5A of the connector 5. The air vents 7a communicates with the fuel transport wick 19. By connecting the fuel cartridge 2 with the fuel cell 1, the fuel from the fuel cartridge 2 is transported to the fuel cell 1 through the fuel transport wicks 6 and 19. When transporting the fuel, the negative pressure occurs inside the fuel cartridge 2. At a time when the inside of fuel cartridge 2 becomes negative pressure, outside air is fed from the air vents 7 to the inside of the fuel cartridge 2 through the fuel transport wicks 19 and 6. Thereby, the negative pressure of the fuel cartridge 2 is removed. In this way, the air vents 7, fuel transport wicks 19 and 6 adjust the pressure inside the fuel cartridge produced by fuel supply. They constitute an air ventilation section 10 for stability of fuel supply. The fuel chamber 3 is provided with one or more pin holes 8 for gas removal, which remove the gas having been produced in the fuel chamber 3.

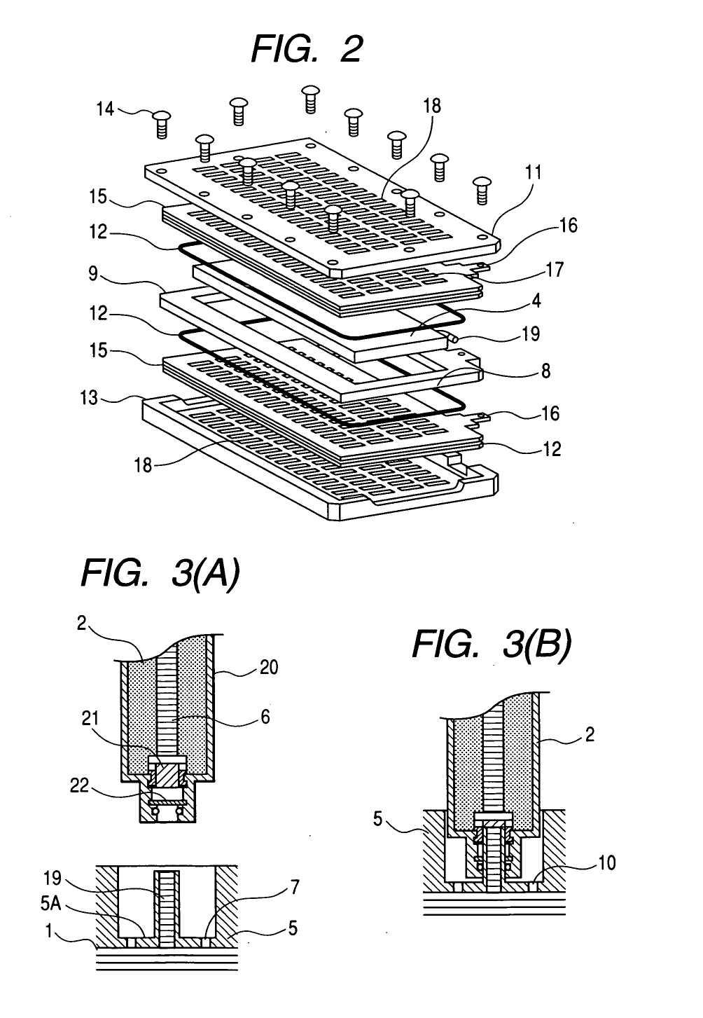

FIG. 2 is an exploded view representing the basic configuration of the fuel cell according to the present embodiment. The fuel chamber 3 of FIG. 1 in the fuel cell is formed of a fuel chamber frame 9, and the fuel in the fuel chamber 3 is held by the capillary action of the fuel wicking structure 4 housed therein. On one surface of the fuel wicking structure member 4, a power generating device 15 is held by the fuel chamber frame 9 and a cathode terminal board (A) 11. The power generating device 15 is made up of a current collector, an output terminal 16 and a MEA (Membrane Electrode Assembly) integrated into one member. The fuel chamber frame 9 and power generating device 15 are sealed by a gasket 12. Further, the same power generation device 15 as the aforementioned one is placed on another surface of the fuel wicking structure member 4, and the device 15 is held by the fuel chamber frame 9 and another cathode terminal board (B) 13 serving as a housing. On another surface of the fuel wicking structure member 4, the fuel chamber frame 9 and the power generating device 15 are sealed by the gasket 12. The whole of the fuel cell 1 having such an arrangement is assembled by screws 14 so that the in-plane pressure thereof will be uniform.

The fuel chamber frame 9 is equipped with the transport wick 19, which is connected with the fuel cartridge connector 5 (not illustrated in FIG. 2). It is further provided with a pin holes 8 for removing the gas produced in the fuel chamber.

The cathode terminal board (A) 11 and the cathode terminal board (B) 13 are provided with a plurality of slits 18 conforming to a plurality of slits 17 which is provided to the cathode of the power generation device 15. The slits 17 and 18 are used for air diffusion. A plurality of fuel supply slits (not illustrated) is formed on the anode surface of the power generation device 15. Thus, the liquid fuel held by the capillary action of the fuel wicking structure member 4 is fed to the anode by assist of the negative capillary attraction.

The negative capillary attraction refers to the negative pressure produced by a decrease in the volume corresponding to the fuel consumed by power generation and like. The negative pressure occurs in the vicinity of the anode on continuous fuel transport path formed by the capillary tube of the anode and the fuel wicking structure 4. Thus, the fuel filled in the capillary tube (pore of the porous material) is fed to the anode by the negative capillary attraction.

The fuel held in the fuel cartridge 2, which is held by the capillary attraction of the fuel transport wick 6, is fed to the fuel wicking structure member 4, by the negative capillary attraction corresponding to the volume of the fuel consumed in the vicinity of the anode, and through the transport wick 19. As the fuel cartridge connector shown in FIGS. 1 and 3 is provided with the air vents 7, even when the negative pressure occurs inside a liquid fuel holding section 20 of the fuel cartridge 2 at the time of supplying the fuel, the section 20 is adjusted to the atmospheric pressure through the air vents 7, transport wicks 19 and 6. By such a ventilation action in the fuel cartridge 2, continuous fuel supply can be ensured.

In the present embodiment, the liquid fuel is held by the capillary tube of the anode connected to the fuel wicking structure 4, the capillary tube of the fuel wicking structure 4 and the capillary tube of the transport wicks 19 and 6, whereby a continuous liquid fuel transport path is formed. Then the fuel from the cartridge 2 is fed to the anode of the generating section 15 through the continuous liquid fuel transport path, by the negative capillary attraction produced by the consumption of the fuel at the anode. Here, assume that P_{A} denotes the capillary attraction of the anode, P_{C} denotes the capillary attraction of the fuel wicking structure 4, and P_{F} denotes the capillary attraction of the air ventilation section including the fuel transport wick 19 and the air vents 7; and further assume that the surface of each capillary tube material is hydrophilic.
P_{F}≦P_{C}≦P_{A}

If the aforementioned expression holds on this assumption, the liquid fuel 34 in the fuel cartridge 2 is attracted by the transport wick 19 and is fed to the fuel wicking structure 4 by the negative capillary attraction produced at the anode. The fuel is further fed to pores of the anode, thereby forming a fuel transport path. In this case, the magnitudes of P_{F}, P_{C} and P_{A} are defined as the wicking levels measured from the liquid surface when the bottom of each of the porous wick materials is immersed in the liquid fuel. If a continuous liquid transport path is formed by the minute pores of these porous wick materials, the transport of fuel continues due to the negative capillary attraction, which is produced by consuming the liquid fuel in the capillary tube of the anode electrode during the power generation.

In this case, the fuel transport wick 6 provided in the fuel cartridge 2 can be made of any material if it has the capillary attraction equal to or less than that of the transport wick 19. There is no restriction to this material. Once the fuel transport wick 6 is structured to penetrate through inside of the fuel cartridge 2 in a vertical direction as shown in FIG. 1 when the cartridge 2 is loaded on the fuel cell 1, the following action is ensured. That is, substantially all the liquid fuel in the cartridge can be used up by the capillary attraction of the fuel transport wick 6, even if the top-bottom position is reversed from the position illustrated in the drawing.

The liquid fuel supplied to the fuel cell can be fed without leaking from the pin holes 8 for gas removal and the air vents 7, or without leaking when the fuel cartridge 2 has been removed, under the following conditions. That is, capillary tube material should be selected or the viscosity of the liquid fuel should be adjusted so that the following equation can be satisfied:
P_{A}−P_{F}>βgh

wherein P_{A} denotes the capillary attraction of the anode, P_{F} denotes the capillary attraction of the air ventilation section including the fuel transport wick 19, and the surface of each capillary tube material is hydrophilic. In this equation, ρ denotes the viscosity of liquid fuel, “g” denotes the gravity acceleration, and “h” denotes the difference in the liquid levels from the fuel cartridge to the anode. Further, the aforementioned requirements (fuel feeding without leaking) can also be satisfied by selecting the material in which that the average radius “rc” of the pores of the fuel transport wick 19 to be air ventilation section will meet the following equation:
rc>2σ cos θ/(P_{A}−ρgh)

where the surface of each capillary tube material is hydrophilic. P_{A} denotes the capillary attraction of the anode, σ denotes the interfacial tension of the liquid fuel, and θ denotes the contact angle of liquid fuel to the porous material of the air ventilation section.

The internal pressure of the fuel cell may have fluctuations due to external factor, for example, changes in atmospheric pressure or an external impactive force. In order not to allow the fuel leakage up to a predetermined pressure P_{S} in the fuel cell-internal pressure even when the fluctuations occur, it is required to satisfy the following conditions. Namely, it is required to select the capillary tube material, to adjust the fuel viscosity and to select the radius of the capillary tube of the transport wick 19 constituting the air ventilation section, under the following equation.
P_{A}−P_{F}>ρgh+P_{S}
rc>2σ cos θ/(P_{A}−ρgh−P_{S})

There are several effective ways to avoid fuel leakage from the fuel cell in real terms. One way is to seal the pin holes 8 for gas removal using a water-repellent porous membrane, thereby ensuring gas/liquid separation. Another is to assist the aforementioned function by the structural design that prolongs the distance from the air vent 7 to the fuel cartridge.

There is no restriction to the material used in the porous fuel transport wick 19 provided with a function of feeding the fuel in the fuel cartridge 2 up to the fuel wicking structure member 4 and a function of forming the ventilation section. Any material can be used if it has a stable strength as a structure member, and a sufficient resistance corrosion in the environment of the fuel cell, without containing any component that may leach out into the aqueous solution of methanol. It is possible to use the following materials: natural fibers such as pulp, porous material made of high polymers, porous material made of synthetic fibers, and porous material made of ceramic or metal. In order to meet the requirements of a great variety of structures, the following materials are preferably used among others: the material formed by a bundle of the flexible single yarn of polyethylene, polypropylene, polyester and polyethylene terephthalate; the natural fiber such as cotton yarn and cellulose; porous materials made of the twisted yarn of nylon, Tetron, polyethylene, polypropylene, acryl, polyurethane, polyphenylene, polyester, polyethylene terephthalate synthetic fibers; or expandable polymer materials having continuous pores. The porous fuel transport wick 19 serving as a part of the air ventilation section is designed and manufactured to have pores with an average radius of 50 through 500 μm. For the pores having an average radius of 50 μm or less, there is a small difference in pore radius when compared to the radius of the anode electrode pore. Further, there is a big resistance in the transport of the liquid fuel for fuel consumption, and this is not preferable. When the average radius is 500 μm or more, the liquid fuel cannot easily be held in the pore on a continuous basis, with the result that the fuel cannot be fed, and the leakage of liquid from the fuel chamber 3 occurs at the same time. In this case, it goes without saying that the pore diameter is not determined uniquely; it is selected with consideration given to the contact angle between the material used and the liquid fuel. The fuel transport wick 6 used in the fuel cartridge can be substantially the same as the transport wick 19 used in the aforementioned fuel chamber. Without the present invention being restricted thereto, other material can also be used. In this case, an average radius of pore of the fuel transport wick 6 is selected in range of 50 through 500 μm. If the radius is equal to or greater than that of the pore of the fuel transport wick 19, the liquid fuel in the cartridge is transported to the anode electrode on a stable basis.

As described above, according to the fuel supply system of the fuel cell-power source of the present invention, the fuel is wicked by the negative capillary attraction produced by the fuel consumption in the anode, through the combination of a plurality of porous materials. This arrangement makes it possible to form the path for transporting the fuel on a stable basis in conformity to the fuel consumption.

Assume that different types of porous materials are connected for the fuel transport pathe. If the contact surfaces between them have poor matching in this case and there is a gap around the contact surfaces, a continuous transport path cannot be formed sufficiently for the fuel transport due to the presence of the air filling this gap. Thus, the capillary attraction cannot be effectively used. This will cause an increase in the resistance to the feed of the liquid fuel. One of the effective ways to solve this problem is configured by interposing a porous material (namely an auxiliary transport member 21) with continuous pores characterized by excellent flexibility and matching in shape between the contact surfaces. The porous materials is, for example, the fibrous porous material such as cellulose, polyethylene, polypropylene, polyester, polyethylene terephthalate, polyurethane, carbon fiber or metallic fiber; or and the spongy porous material of high polymer. This method provides sufficient formation of a liquid transport path on the contact surfaces and reduces the resistance to the movement of liquid.

In this case, the average radius rc of the continuous pores of the auxiliary transport member 21 is determined in such a way the following equation will be satisfied:
ρghc=2σ cos θc/rc=2σ cos θf/rf+ρghf

This arrangement will ensure a stable supply of liquid fuel to the anode free from leakage. In this equation, “rf” denotes the average radius of the capillary tube for transport formed by the above-mentioned transport wick, “hf” denotes the fuel charging level of fuel container, “hc” denotes the bubble pressure barrier expressed in terms of a water column, “σ” denotes the viscosity of liquid fuel, and “θc” and “θf” denote the contact angles of liquid fuel to the auxiliary transport member and the transport wick, respectively. The bubble pressure barrier hc notes pressures of the impact and others applied from the outside to the fuel cell equipped with the fuel cartridge of the present invention. According to the aforementioned relational equation, liquid fuel in the cartridge 2 is fed to the transport wick 19 of the fuel cell 1 by the capillary attraction of the fuel transport wick 6 incorporated in the cartridge, and by the capillary attraction higher than the head of the fuel in the fuel cartridge 2, without any leakage of liquid due to the pressure such as external impact. Thus, a fuel transport path is formed.

No restriction is imposed on the material used in the fuel chamber frame 9, if it has substantially good insulating properties, the strength for supporting the fuel cell structure, and resistance to corrosion in the operating environment. It is possible to use the high-density vinyl, high-density polyethylene, high-density polypropylene, epoxy resin, polyether ether ketone, polyether sulfone, polycarbonate or substances formed by glass-reinforcement of these materials. One of the following material: metal and alloy materials such as carbon plate, steel, nickel, other light-weight titanium, aluminum, magnesium; intermetallic compound represented by copper-aluminum; and various types of stainless steel, is also used as the fuel chamber frame 9 by forming nonconducting surfaces thereof. Alternatively, a resin with insulating property may be coated on the material.

FIG. 3 (A) is a diagram representing the overall structure wherein the connector 5 for the fuel cartridge of the fuel cell 1 is designed as a male connector while the tip of the fuel cartridge 2 is formed as a female connector.

The connector 5 for fuel cartridge is formed at a part of the fuel chamber frame 9 of the fuel cell 1. A part of the fuel transport wick 19 serving as the male connector portion is arranged in an opened connector case (recess) 5A. The fuel transport forms the liquid fuel transport path for transport from the fuel cartridge 2 to the fuel wicking structure member 4. The part of the connector 5 for fuel cartridge is provided with at least one air vent 7 having an air vent function. The female connector of the fuel cartridge comprises the fuel transport wick 6 and a slit valve 22. The female connector is provided with the auxiliary transport member 21 for ensuring stable contact of the male connector on the side of the fuel cell with the transport wick 19.

FIG. 3 (B) is a cross sectional view showing the overall structure wherein the fuel cartridge 2 is mounted on the fuel cell 1.

When the fuel cartridge 2 is inserted into the connector 5 of the fuel cell 1 at the time of loading the fuel cartridge, the male connector portion of the transport wick 19 penetrates the slit valve 22 to come in contact with the auxiliary transport member 21 at the tip of the female connector inside the cartridge 2. Then the liquid fuel transport path of the fuel transport wick 6, the transport wick 19 and the fuel wicking structure member 4 is formed from the fuel cartridge to the inside the fuel chamber 3 of the fuel cell. When power generation is performed in the anode, the fuel is supplied by the negative capillary attraction by the amount having being consumed. When the fuel cartridge 2 and fuel cell 1 are connected, they may effectively connected securely to each other by screws, a hook or ratchet. If the slit valve 22 is a check valve, the counter flow of fuel can be prevented. The structure can be simplified if replaced by a filter or the like.

In order to produce a fuel cartridge preferably used as the aforementioned fuel transport system, a porous wick and auxiliary transport member are provided. This arrangement provides a stable fuel transport path, and ensures fuel supply characterized by the reduced resistance to liquid flow. Further, if an air ventilation section or slit valve mechanism is arranged, a safe fuel cartridge free from liquid leakage can be provided.

The fuel cartridge is filled with an aqueous solution of methanol as the fuel of a predetermined density. The fuel density varies according to the properties of the electrolytic membrane. To be more specific, the aqueous solution of methanol having a lower density is used for the perfluorocarbon membrane having a large crossover of methanol, while the aqueous solution of methanol having a higher density is employed for the hydrocarbon membrane based sulfonic acid. Generally, when the liquid fuel is supplied directly, 3 through 10 wt % of aqueous solution of methanol is used for the perfluorocarbon based electrolytic membrane, and 10 through 40 wt % of aqueous solution of methanol is used for the hydrocarbon based electrolytic membrane. When using the fuel supply system based on the capillary attraction of a wicking member, the percentage of substantial contact of the liquid fuel with the anode is reduced. Accordingly, the substantial cross overflow of the methanol and water is reduced. Thus, as compared with the cases where the fuel is directly supplied without wick, operation can be performed without heat generation in the cathode based on the crossover, flooding of the cathode or deterioration of the fuel cell performance, despite increased density of the fuel. For example, in case where the perfluorocarbon based electrolytic membrane is used, even if increasing the fuel density up to maximum 25 wt %, the stable operation of the fuel cell is ensured. In case where the hydrocarbon based electrolytic membrane is used, even if increasing the fuel density up to maximum 40 wt %, the stable operation of the fuel cell is ensured. It goes without saying that use of the electrolytic membrane of still smaller crossover allows direct use of the fuel of still higher density. This improves the availability efficiency of the fuel, and permits the operation to be performed with the fuel of higher density. Thus, the energy density of the fuel to be used is increased and this leads to a substantial increase in the power supply energy density per charge of fuel, i.e. a much prolonged power generation time duration.

The fuel transport speed and leakage prevention effect in the fuel transport of the present embodiment are determined by such characteristics as the material constituting the capillary tube and pore radius. However, if fuels having different densities are used, the surface tension, solid/liquid contact angle, liquid density and others are subject to change according to the methanol density, and the transport speed and liquid leakage prevention effect of the capillary transport material will be changed. Accordingly, to ensure compatibility among the fuels having different densities, it is effective to use the method of adjustment wherein an electrochemically inactive substance is added to the liquid fuel to change the solid/liquid contact angle, viscosity and others. For example, in order to change the fuel viscosity, it is possible to add one or more substances selected from among higher alcohols such as ethylene glycol, heptanol and octanol; saccharides such as ribose, deoxyribose, glucose, fructose, galactose and sorbitol; and cellulose ethers such as methyl cellulose, ethyl cellulose and carboxyl methyl cellulose as well as agar and gelatine. The amount to be added depends on the degree of viscosity to be set. Approximately 0.1 through 1 mol % is the amount preferably adopted. The aqueous solution of methanol with the aforementioned substances added thereto can be adjusted to a desired density, and osmotic pressure of the liquid fuel can be increased. Consequently, a spillover effect where the cross over of water and methanol can be decreased, and this arrangement allows the availability efficiency to be increased.

Further, addition of the so-called pigment of colored solid fine particulate to the liquid fuel facilitates identification of the fuel, visual observation of the remaining amount of fuel, checking of the usage of the fuel. This will provide an effective method for ensuring safety of the power supply system and fuel supply system. It is possible to add dyes to color the liquid fuel. In this case, however, the dyes are dissolved in the liquid fuel, and this may result in suction to the anode, and cause poisoning. Alternatively, accelerated deterioration of fuel cell or constituent materials may be caused by leaching out of the components from the fuel cell. However, use of the so-called pigment with the colored solid fine particulate dispersed therein ensures safety to be improved, without losing the reliability of the fuel cell power supply.

Commercially available pigments that can be used for coloring by addition include: C.I. Pigment Yellow 24, 101, 108, 109, 110, 117, 120, 123, 138, 139, 135, C.I. Pigment Orange 2, 5, 17, 24, 31, 36, 38, 40, 43, C.I. Pigment Red 1, 2, 3, 4, 5, 7, 9, 10, 12, 14, 15, 17, 18, 22, 23, 31, 48, 49, 50, 53, 57, 58, 60, 63, 64, 81, 83, 87, 112, 122, 123, 144, 146, 149, 166, 168, 170, 171, 175, 176, 177, 178, 179, 185, 187, 188, 198, 190, 192, 194, 208, 209, 216, 243, 245, C.I. Pigment Violet 1, 3, 19, 23, 31, 32, 33, 36, 38, 49, 50, C.I. Pigment Blue 1, 2, 15, 16, 22, 25, 63, C.I. Pigment Green 8, 10, 12, 47, C.I. Pigment Brown 1, 5, 25, 26, 28 and C.I. Pigment Black 1, 7. There is no restriction to the color tone for coloring. Use of the blue-based pigment, i.e. the pigment based on C.I. Pigment Blue is said to yield a repellent feel when used for beverage. This will be an effective way to give a warning and to ensure safety.

The embodiments of the present invention have been described so far. The following will give further details to explain some embodiments most characteristic of the present invention:

### Embodiment 1

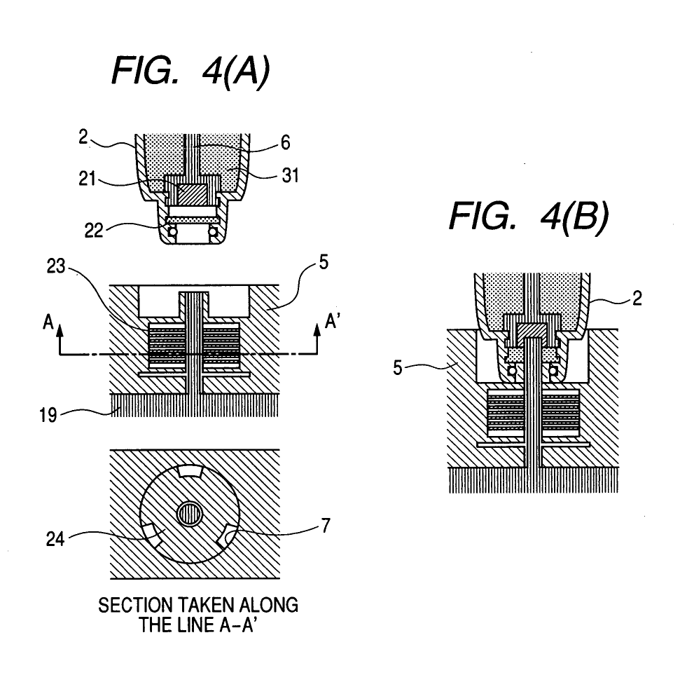

FIG. 4 (A) shows a relationship of a male connector portion of the connector 5 of the fuel cell and a female connector of the fuel cartridge 2. In the present embodiment, the air ventilation section of the fuel cell is designed in a collector structure.

The connector 5 is provided in a part of the fuel chamber frame 9 of the fuel cell 1. The transport wick 19 as a male connector portion is connected with the fuel wicking structure member, and performs the function of transporting the fuel. The transport wick 19 is made of a bundle of the polypropylene fibers and the average radius of the capillary tube formed between the fibers was about 200 μm. A part of the connector 5 is provided with a collector type air ventilation section 23 performing the functions of fuel transport amount control and fuel leakage prevention. This collector structure is made of a plurality of collector fins 24 having at least one notch 7 with the transport wick 19 used as an axis, as shown in FIG. 4 A-A′. This notch 7 serves as air vent. The female connector provided on the side of the fuel cartridge 2 is composed of the fuel transport wick 6 and slit valve 22. The tip of the female connector is equipped with an auxiliary transport member 21 for stabilizing connection with the male connector portion (porous fuel transport wick 19) of the fuel cell 1. The auxiliary transport member 21 is component having a notch for inserting the male connector 5 into the porous urethane foam having continuous pores having an average diameter of 200 μm. This arrangement ensures a fuel transport path to be formed between the male connector 5 of the fuel cell and the fuel transport wick 6 provided inside the fuel cartridge. This arrangement also reduces the fluid resistance at the time of fuel transport, without an excess space being formed on the contact surface.

FIG. 4 (B) shows the overall view of the cross sectional structure when the fuel cartridge 2 is loaded on the fuel cell 1.

When the fuel cartridge 2 is inserted in the male connector 5 of the fuel cell 1, the male connector portion penetrates the slit valve 22, and is connected with the fuel transport wick 6 through the auxiliary transport member 21. The liquid fuel 31 in the fuel cartridge 31 is fed to the anode of the fuel cell, by the negative capillary attraction resulting from power generation, through the continuous fuel transport path, which formed by the fuel transport wick 6, auxiliary transport member 21, transport wick 19 and fuel wicking structure member 4.

The fuel cell 1, having the structure shown in FIG. 1, produced in the aforementioned procedure, was loaded with the fuel cartridge filled with 30 wt % of aqueous solution of methanol. A power generation test was conducted at the room temperature. The power output was 2.4 volts, 0.8 watts, even if this fuel cell 1 was held in different positions by hand. There was no change in power output regardless of the position. When it was shaken by hand, power generation continued without any liquid leakage.

The present embodiment represents the power generating device 15 composed of a plurality of MEAs arranged electrically in series on one and the same plane. It is designed in a fuel cell structure having a porous fuel wicking structure member 4. The fuel wicking structure member 4 is connected with the fuel transport wick 6 through the auxiliary transport member 21 and transport wick 19. The fuel cartridge connector is equipped with an air ventilation section having a collector structure. It further constitutes a male connector, and performs the function of connecting with the fuel cartridge. This arrangement creates a continues liquid transport path by the capillary tube from the fuel cartridge to the anode electrode. The fuel transport path is designed in such a way that there is a gradual decrease in the average pore diameter from the fuel cartridge to the electrode; namely, the average radius is about 200 μm on the transport wicks 6, 21 and 19 used in the fuel cartridge 2 and the fuel chamber frame 9, about 50 μm on the fuel wicking structure member 4, and about 20 μm on the anode electrode. This design allows the fuel of the connector 5 for fuel cartridge to be fed quickly to the fuel wicking structure member 4. Thus, the fuel chamber is filled with fuel, and stable formation of the fuel transport path is ensured.

### Embodiment 2

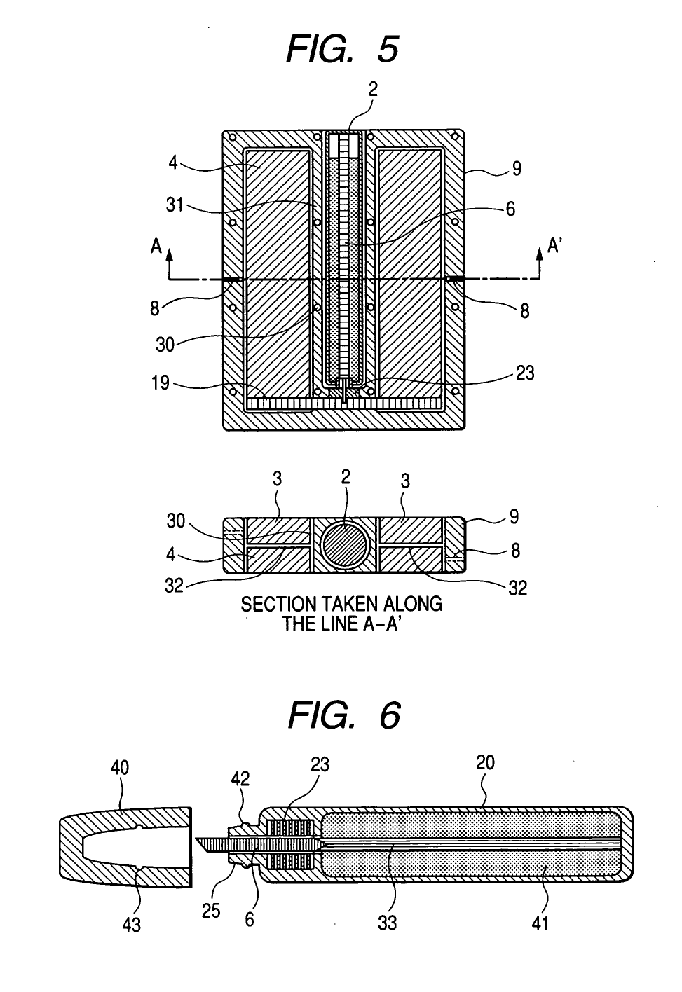

FIG. 5 shows the longitudinal section structure of the fuel chamber 3 of the fuel cell of the present invention. The fuel cell 1 is composed of the fuel chamber frame 9, gasket 12, power generation device 15, cathode terminal board A11, and cathode terminal board B13, although not illustrated, similarly to the cases in the first embodiment. The fuel wicking structure 4 is incorporated in the fuel chamber 3. The wicking structure member uses the foam SUS 316L provided with pores having an average radius of 50 μm, similarly to the case of the first embodiment. The fuel cell 1 is designed in a structure wherein a total of 12 MEAs arranged on both sides of the fuel chamber 3 are arranged in series. A major difference from the first embodiment is that the cartridge is incorporated in the fuel cartridge holder 30 arranged at the center of the fuel cell 1. In order to provide the function of avoiding the short-circuiting of the liquid between the power generation devices 15 arranged in series sandwiching the fuel chamber 3, the fuel wicking structure member 4 is separated into two pieces and a liquid short circuit preventive board 32 is inserted between these two pieces. The connector 5 for fuel cartridge has an air ventilation section 10 of collector structure and is designed in a male connector structure. The fuel cartridge 2 uses the female connector cartridge having the same structure as that of the first embodiment.

The power supply manufactured in the aforementioned manner measured 120 by 100 by 15 mm. It was loaded with the fuel cartridge filled with 30 wt % of aqueous solution of methanol, and a power generation test was conducted at the room temperature. The power output was 4.0 volts, 1.28 watts. This power supply was substantially free from a drop of power supply voltage resulting from liquid short-circuiting between the MEAs caused by the ionic substance present in the fuel chamber. When designed in a structure in which a voltage terminal was led from each MEA, the voltage of each MEA was within about 0.33±0.02. The fuel cell in the present embodiment was free of any change in power output when held at any position by hand. Even when shaken by hand, continued power generation was ensured without leakage of liquid.

### Embodiment 3

In the present embodiment, the fuel cartridge 2 was designed as a male connector type, as shown in FIG. 6. This connector was equipped with a collector type air ventilation section, and a female connector is used on the side of the fuel cell 1.

The fuel cartridge 2 is made of at least two chambers; one for a polypropylene connector 25 and the other for a liquid fuel holding section (liquid container) 20. The polypropylene connector 25 is composed of a collector type air ventilation section 23 having a collector, and a polypropylene fuel transport wick 6 penetrating the air ventilation section 23 and having an average pore radius of 200 μm. The liquid fuel holding section 20 is linked with another auxiliary transport member 33 connected with the fuel transport wick 6. The auxiliary transport member 33 is arranged so as to reach the other end inside of the liquid fuel container 20. Further, the auxiliary transport member 33 is surrounded by a filling material made of a hydrophilic polyester fiber having a void ratio of about 90 vol %. Liquid fuel is held in this position. Instead of using the auxiliary wick 33, only the fuel transport wick 6 may be used for fuel supply. However, if using a fuel supply path formed by connection of the fuel transport wick 6 and the auxiliary wick 33, it is possible to completely use the liquid fuel of the container of the fuel cartridge. A virgin fuel cartridge 2 is sealed with the airtight cap 40. To ensure airtightness of the cap, the connector portion 25 of the fuel cartridge has a ring-like male protrusion 42 which can fit with a ring-like female groove 43 on the inner surface of the cap 40. At the time of loading the fuel cartridge 2 to the fuel cell 1, the cap 40 is removed and the fuel cartridge 2 is inserted into the connector 5 of the fuel cell.

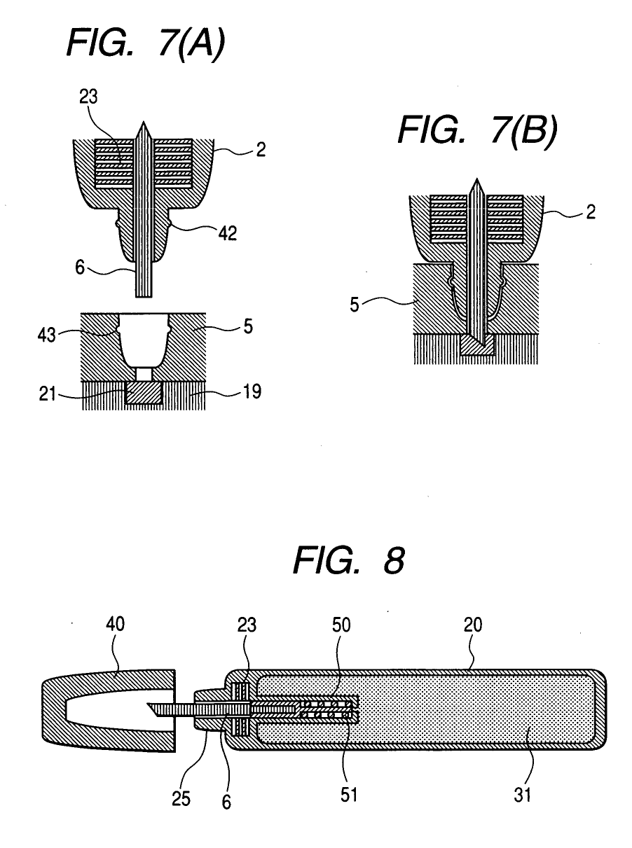

FIGS. 7 (A) and (B) show the case where the connector 5, which is integrally provided at the fuel chamber frame 9, is a female type. The connector 5 for fuel cartridge is provided with the same female groove 43 as that of the cap 40. The spent fuel cartridge is collected for recycle or discarded after being capped with the cap 40. This will prevent the remaining fuel liquid from leaking and will ensure handling safety.

In order to ensure sufficient contact between the transport wick 19 of the fuel cell 1 and the fuel transport wick 6 of the fuel cartridge 2, an auxiliary transport member 21 is provided at the female connector portion 5. A part of the fuel transport wick 6 protrudes from an outlet of the fuel cartridge, and it is inserted into the female connector portion 5 of the fuel cell during using of the fuel cartridge. The auxiliary transport member 21 uses the porous cellulose fiber mat containing continues pores having an average radius of 175 μm.

### Embodiment 4

In the present embodiment, a fuel cartridge 2 is a male connector type as shown in FIG. 8, which is provided with a low-resistance collector type air ventilation section 23 having a large transport capacity. A female connector portion is provided on the fuel cell 1 side. In the fuel cartridge 2, a transport wick holder 50 having a stop valve function is provided.

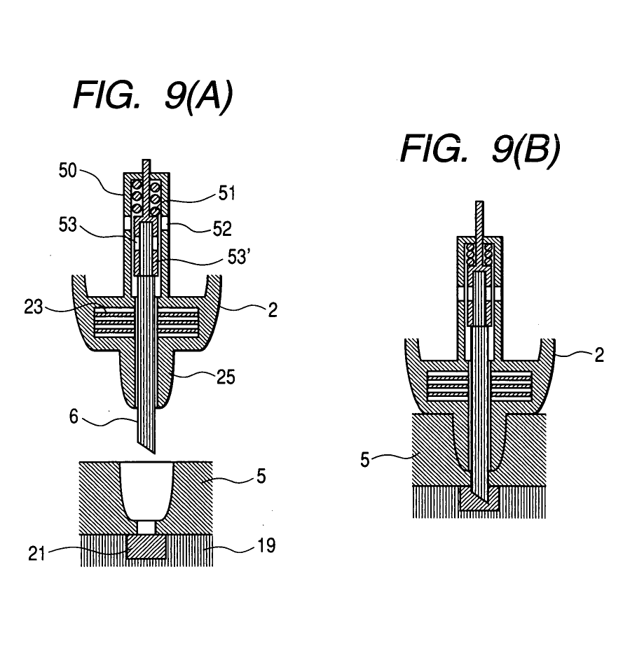

The fuel cartridge 2 is made of at least two chambers; one for a polypropylene connector portion 25 and the other for a liquid fuel holding section (liquid fuel container) 20. The polypropylene connector portion 25 is composed of a low-resistance collector type air ventilation section 23 having a large transport capacity, and a polypropylene fuel transport wick 6 penetrating the air ventilation section 23. The fuel transport wick 6 has an average pore radius of 200 μm. A transport wick holder 50 is approximately cylindrical in form and is assembled integrally with the connector portion 25. The transport wick holder 50 is used for holding the transport wick 6 and is located at a center inside of fuel cartridge 2. As shown in FIG. 9(A), a part of the fuel transport wick 6 is inserted into the transport holder 50. The inserted portion of the fuel transport wick 6 is provided with a wick supporter 53′ having at least one liquid hole 53. The fuel transport wick 6 is supported by a spring 51 via the wick supporter 53′ in the transport wick holder 50. The holder 53′ and liquid hole 52, 53 constitute a gate for the fuel path. With this arrangement, the fuel transport wick is integrally assembled with the transport holder 50. The transport wick holder 50 is also provided with at least one liquid passage hole 52. When the fuel cartridge 2 is not loaded (it may be capped with the cap 40), the fuel transport wick 6 is kept protruded by the pressure of the spring 51. At this time, the liquid passage holes 52 and 53 are closed without communicating with each other. When loading the fuel cartridge is loaded to the fuel cell 1 by removing the cap 50, the fuel transport wick 6 is retracted into the liquid fuel holding section 20, as shown in FIG. 9 (B). This arrangement causes the liquid passage hole 53 to communicate with the liquid passage holder 52, whereby a fuel transport path is formed.

The aforementioned arrangement permits a dual sealing structure to be formed using the collector type air ventilation section and the stop valve mechanism of the cap. This structure prevents leakage of the liquid held inside, even if the cap has been removed when the cartridge is not used.

What is claimed is:

1. A fuel cartridge for supplying liquid fuel to a fuel cell, and said fuel cartridge being applicable to the fuel cell comprising: a power generating composed of an anode for oxidizing the liquid fuel, a cathode for reducing oxygen, and a polymer electrolyte membrane being interposed between said anode and cathode; and a fuel wicking structure for feeding the liquid fuel to said anode, said fuel cartridge comprising:
a fuel container for storing the liquid fuel; and
a porous fuel transport wick for transporting the liquid fuel to said fuel cell, and which is incorporated in said fuel container;
wherein said fuel cartridge is configured to feed the liquid fuel stored in said cartridge to said fuel cell through said porous fuel transport wick, with assist of the negative capillary attraction which occurs in said fuel wicking structure depending on fuel consumption at said anode.

2. A fuel cartridge for use in a fuel cell; the fuel cartridge comprising:
a fuel container for storing liquid fuel;
a passage hole for allowing passage of the fuel, and which is provided at an outlet side of said fuel container;
a porous fuel transport wick incorporated in said container; and
an auxiliary transport member formed of a porous flexible material, and which is located in said passage hole and is connected with the porous fuel transport wick.

3. A fuel cartridge according to claim 2, wherein an average pore radius rc of said auxiliary transport member meets the following equation:
ρghc≦2σ cos θc/rc≦2σ cos θf/rf+ρghf
wherein “rf” denotes an average radius of capillary tubes formed in said porous transport wick, “hf” denotes a fuel charging level in said fuel container, “hc” denotes an babble pressure barrier expressed with a water column height, “σ” denotes a viscosity of liquid fuel, “θc” denotes a contact angles of liquid fuel to said auxiliary transport member, and “θf” denote contact angle of liquid fuel to said porous fuel transport wick.

4. A fuel cartridge according to claim 1,
wherein said fuel cartridge further comprising:
a wick holder for holding said porous fuel transport wick in said fuel container, and which is configured to be capable of opening and closing a fuel path communicated with said porous fuel transport wick by working with attaching and detaching of said fuel cartridge to said fuel cell.

5. A fuel cartridge according to claim 4,
wherein said wick holder is capable of opening and closing said fuel path by a gate and spring assembly working with said attaching and detaching.

6. A fuel cartridge according to claims 1 or 2,
wherein said fuel cartridge further comprising:
a collector type air ventilation section for rendering the inside of said fuel container atmosphere pressure through said porous fuel trans port.

7. A fuel cartridge according to claim 1,
wherein said porous fuel transport wick also serves as a male connector element or a female connector.

8. A fuel cartridge according to claim 2,
wherein said auxiliary transport member also serves as a female connector.

9. A fuel cell using liquid fuel comprising:
a power generating section with an anode for oxidizing the liquid fuel, a cathode for reducing oxygen, and a polymer electrolyte membrane being interposed between said anode and cathode;
a fuel wicking structure for wicking the liquid fuel by capillary attraction and for feeding the liquid fuel to said anode; and
a fuel cartridge for supplying the liquid fuel, and which has a fuel container for storing the liquid fuel and a porous fuel transport wick incorporated in said fuel container.
wherein said fuel cartridge is configured to feed the liquid fuel stored in said cartridge to said fuel cell through said porous fuel transport wick, with assist of the negative capillary attraction which occurs in said fuel wicking structure depending on fuel consumption at said anode.
